(19) United States
(12) Patent Application Publication
(10) Pub. No.: US 2005/0190533 A1
(43) Pub. Date: Sep. 1, 2005

(54) Friction hinge assembly and display tilt device

(76) Inventors: Scott Hultzman, Putnam, CT (US); Joseph Spanedda, Scituate, RI (US); Bruce Parkes, Cranston, RI (US)

Correspondence Address: KENYON & KENYON, ONE BROADWAY, NEW YORK, NY, 10004, US

(21) Appl. No.: 10/973,323

(22) Filed: Oct. 25, 2004

Related U.S. Application Data
(63) Continuation-in-part of application No. 10/789,747, filed on Feb. 26, 2004, now abandoned.

(51) Int. Cl. G06F 1/16

(52) U.S. Cl. 361/683; 16/221

(57) ABSTRACT

A lottery ticket terminal is disclosed. The lottery ticket terminal includes a friction hinge assembly wherein the friction hinges are configured to be disposed at a distance from a pivot point at which two objects are pivotably connected.

### RELATED APPLICATIONS AND PRIORITY CLAIM

This application claims priority to co-pending U.S. patent application Ser. No. 10/789,747 filed Feb. 26, 2004. The entire disclosure of said application is incorporated herein by reference thereto.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Friction hinges are often used to hold a joint in a particular position, or to slow or restrict the movement of one part of a hinged structure relative to another part. For example, friction hinges may be used to hold open cabinet doors or hold the monitor portion of a laptop computer in an upright position. Conventionally, friction hinges are constructed such that a torque exists between two objects or between two parts of a single object, having an axis of rotation in common. In conventional devices, the friction hinge is applied at the pivot, or the joint, of the two parts.

### BRIEF DESCRIPTION OF THE DRAWINGS

FIG. 1 illustrates an example conventional friction hinge.

FIG. 2 illustrates example linkage arms of a friction hinge assembly, according to an example embodiment of the present invention.

FIG. 3 illustrates an example display tilt mechanism having two friction hinge assemblies, according to an example embodiment of the present invention.

FIG. 4 illustrates an example lottery ticket terminal, according to an example embodiment of the present invention.

FIG. 5 illustrates the example lottery ticket terminal of FIG. 4, with the monitor in a raised position, according to an example embodiment of the present invention.

### DETAILED DESCRIPTION OF EXAMPLE EMBODIMENTS

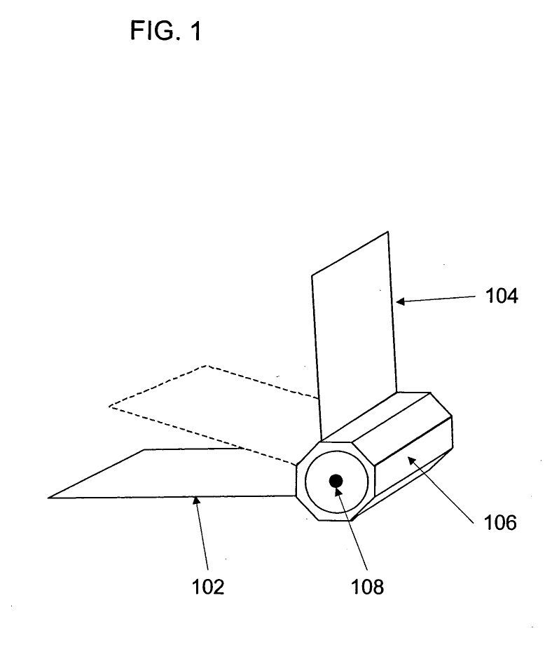

FIG. 1 illustrates an example conventional friction hinge. Part 102 is connected to part 104 via friction hinge 106. The dashed line indicates the placement of part 104 after having been moved to another position. It may be appreciated that the friction hinge is applied at the pivot 108 between the two parts.

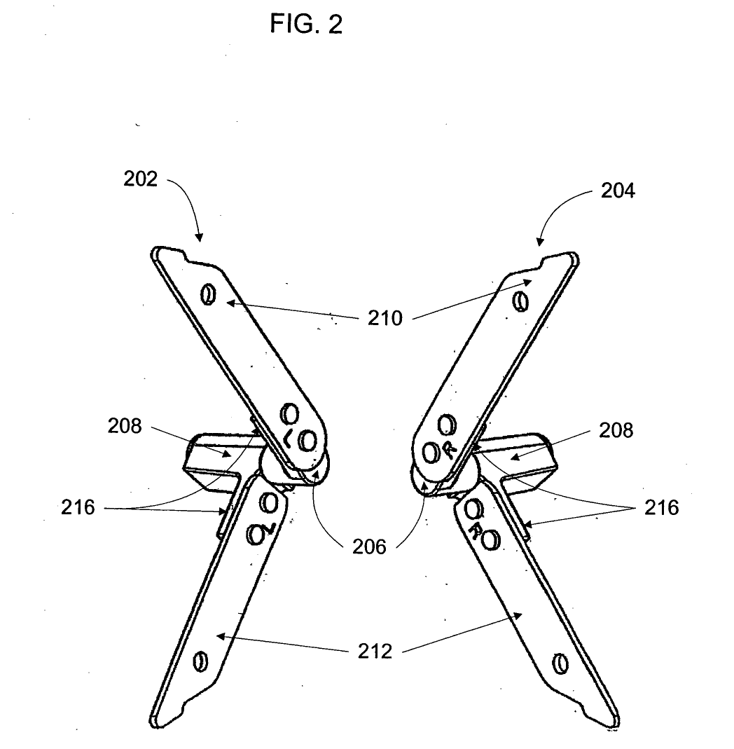

FIG. 2 illustrates example linkage arms of a friction hinge assembly, according to an example embodiment of the present invention. A left linkage arm 202 and a right linkage arm 204 are shown. Both of the linkage arms include a top segment 210 and a bottom segment 212. The top segment 210 and bottom segment 212 are joined at a pivot point 206. The top segment 210 and bottom segment 212 are joined by friction hinge 208, which may be a conventional friction hinge. The top segment 210 and bottom segment 212 may be joined to the friction hinge 208 by screws, pins, or rivets using holes or bosses already provided in the hinge. For example, a low profile pre-manufactured friction hinge may be used, where the top segment 210 and bottom segment 212 are attached to each of the two retainers 216 extending radially from the center of the hinge. It may be appreciated that in some instances a single linkage arm may be used, or more than two linkage arms may be used.

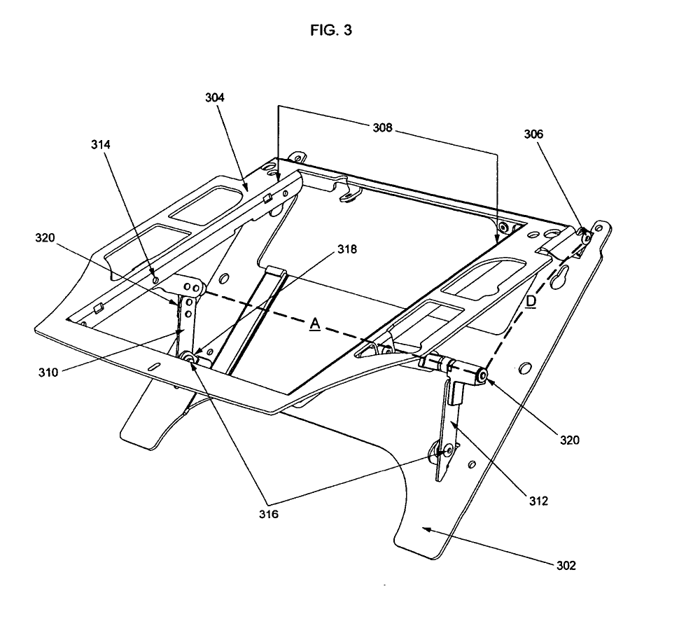

FIG. 3 illustrates an example display tilt device having two friction hinge assemblies, according to an example embodiment of the present invention. A support panel 302 is attached to a display panel 304 at a pivot point 306. The display panel 304 may include an opening 308 where a monitor, or other device configured to display or be displayed may protrude. The opening 308 may be provided in order to achieve a low profile for the protruding device. If opening 308 is not present, the device may be used with, for example, a flat screen monitor. Support panel 302 may be attached to a fixed surface, or remain unattached for portability. Left linkage arm 310 and right linkage arm 312 may be pivotably attached to the plates as shown. Top pivots 314 and bottom pivots 316 may include, for example, pins and washers attached to connectors 318. Rivets may also be used to maintain constant friction, allowing for a rattle free pivot and economic manufacturing. The left linkage arm 310 and right linkage arm 312 may be attached anywhere along the support panel 302 and display panel 304.

Due to the arrangements contemplated in the present invention, the friction hinges 320 in the linkage arms 310, 312 are not fixed at the pivot point 306. For example, the linkage arms 310, 312 may be connected at pivot points that are the same distance away from the pivot point, shown as distance D in FIG. 3. Additionally, the linkage arms 310, 312 may be located a distance A away from each other.

Friction hinges 320 are thereby disposed at a distance from the pivot point 306 between support panel 302 and display panel 304. The friction hinges 320 may be used to provide the torque necessary to maintain the position of the display panel 304 relative to the support panel 302. Greater stability and a ease of assembly is provided by the arrangement shown in FIG. 3.

The arrangement of the display tilt device shown in this example embodiment has the advantage that the height and angle of the display panel 304 may be adjusted with minimal effort. In the example embodiment, the design allows the display panel to be moved upward with an applied force and remain stable, while requiring an applied force to move the display panel downwards. Therefore, once adjusted to a certain height, the display panel 304, as well as any object protruding from opening 308, are supported in a stable manner. Accordingly, the arrangement is configured to withstand motions such as small taps and minor forces without falling out of its current position, however, it may also be moved to a new position with ease. Alternatively, by using bi-directional friction hinges or springs, alternative configurations of force resistance may be provided, e.g., a comparatively much larger force may be required to move the display panel downward than upward.

It will be appreciated that although two friction hinge assemblies are shown in the example display tilt mechanism of FIG. 3, fewer or more friction hinge assemblies may be used as appropriate. One or more bidirectional friction hinges or spring assisted hinges may be used. Furthermore, it is contemplated that other mechanisms capable of providing the necessary torque may be used in place of the friction hinge, such a detent hinge. In another exemplary embodiment, the left linkage arm 310 and right linkage arm 312 may be slideably coupled to tracks located on the support panel 302 and the display panel 304 such that the distance between the friction hinge and the main pivot increases (or decreases) as the angle between the display panel 304 and the support panel 302 increases (or decreases). The tracks may include detents at various intervals in order to provide additional stability. It will be appreciated that an alternative configuration may be provided so that the distance between the friction hinge and the main pivot decreases (increases) as the angle between the display panel 304 and the support panel 302 increases (decreases).

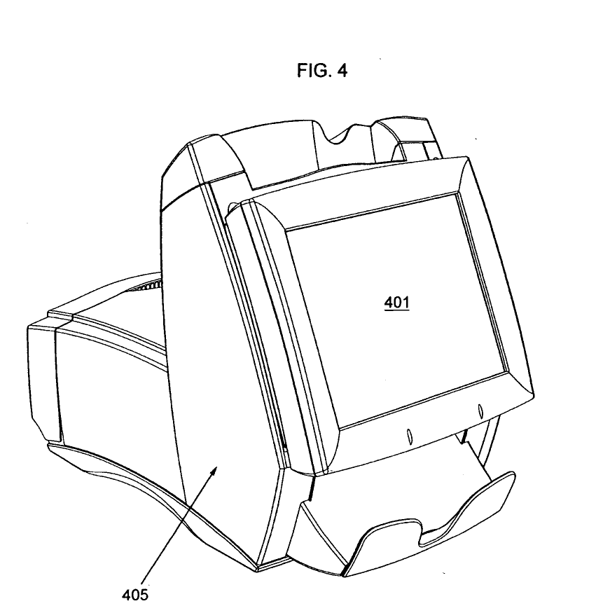

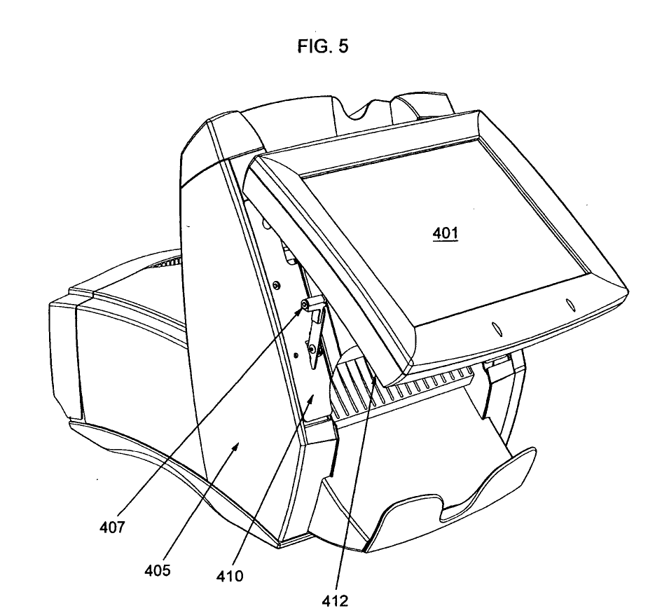

FIG. 4 illustrates an example lottery ticket terminal, according to an example embodiment of the present invention. FIG. 4 shows a touch screen monitor (“touch screen”) 401 attached to a base 405 by a display tilt mechanism including two friction hinge assemblies, arranged as in FIG. 3. The display tilt mechanism is not visible in this view, however portions of it are shown in FIG. 5. The touch screen 401 may be, for example, an CRT monitor equipped with a touchscreen or an LCD touch screen monitor. Base 405 may house electronic components such as a processor, memory drives, disk drives, printer, software capabilities, and external device connectors needed to run the lottery game.

FIG. 5 illustrates the example lottery ticket terminal of FIG. 4, with the monitor in a raised position, according to an example embodiment of the present invention. The support panel 410 is shown attached to the base 405 of the lottery terminal. A friction hinge 407 and linkages are shown and another friction hinge and linkages are hidden by the touch screen 401. The display panel 412 is attached to the back of the touch screen 401.

The example lottery ticket terminal shown in FIGS. 4 and 5 has the advantage that the touch screen position may be adjusted by pulling or pushing on the touch screen frame. This may be intuitive to the user and therefore, the terminal is simple to adjust. Also, it is possible to accommodate users of varying heights and varying light/glare conditions by repositioning the touch screen.

Furthermore, within the range of motion, there are no restrictions of where the position of the touch screen may be held. Therefore, the touchscreen may be capable of maintaining any position within, for example, a 30 degree or 45 degree range of motion. Accordingly, an infinite range of angle adjustments are possible within the allowed range of motion. In addition, detents or similar devices may be included in order to add extra stability to the monitor in certain selected positions.

Furthermore, the example lottery ticket terminal shown in FIGS. 4 and 5 has the advantage that it is not difficult to assemble and repair. Because the monitor and the display tilt mechanism may be assembled separately, they may disassembled and repaired or replaced separately. This modularity of design allows for replacement or repair of only what is minimally necessary to keep the lottery terminal operating.

Furthermore, the touch screen of the example lottery ticket terminal is held in stable manner. The touch screen will not flex, spring, or bounce when pressed to select a touch screen button. Additionally, when excessive force is applied, the touch screen simply lowers into the most downward position. Since stops or detents are not necessary for stability, the possibility of broken stops or detents due to excessive force may be eliminated.

1. A lottery ticket terminal, comprising:
a monitor coupled to a first object;
a base coupled to a second object, the first object pivotable coupled to the second object at a pivot point; and
a friction hinge configured to be pivotably coupled to the first object and the second object, disposed at a distance from the pivot point.

2. The lottery ticket terminal of claim 1, further comprising:
at least one arm having a first end configured to be pivotably coupled to the friction hinge and a second end configured to be pivotably coupled to one of the two objects.

3. The lottery ticket terminal of claim 1, wherein the two objects are part of the same structure.

4. The lottery ticket terminal of claim 3, wherein the single structure is folded at a folding axis to create two sections and the friction hinge is pivotable coupled to each of the two sections at a distance from the folding axis.

5. The lottery ticket terminal according to claim 1, wherein the base houses at least one of a processor, a memory device, a disk drive, a printer, a scanner and an external device connector.

6. A lottery ticket terminal, comprising:
a monitor support frame;
a base pivotably coupled to the monitor support frame at a first pivot;
means for applying a torque to a first pivot point between the monitor support frame and the base, wherein the means is disposed at a distance from the first pivot point.

7. The lottery ticket terminal of claim 6, wherein the means is pivotably coupled to both of the monitor support frame and the base.

8. The lottery ticket terminal of claim 6, wherein the monitor support frame and the base are two sections of a single structure.

9. The lottery ticket terminal of claim 8, wherein the single structure is folded a folding axis delineating the two sections and the friction hinge is pivotably coupled to each of the two sections at a distance from the folding axis.

10. The lottery ticket terminal according to claim 6, wherein the base houses at least one of a processor, a memory device, a disk drive, a printer, a scanner and an external device connector.

11. A lottery ticket terminal, comprising:
a display panel;
a support panel pivotably coupled to the display panel at a main pivot;
a friction hinge pivotably coupled to the display panel and the support panel, wherein the friction hinge is disposed at a distance from the main pivot.

12. The lottery ticket terminal of claim 11, further comprising:
at least one arm having a first end configured to be pivotably coupled to the friction hinge and a second end configured to be pivotably coupled to one of the display panel and the support panel.

13. The lottery ticket terminal of claim 12, further comprising:
a top arm having a second end configured to be pivotably coupled to the display panel; and
a bottom arm having a second end configured to be pivotably coupled to the support panel.

14. The lottery ticket terminal of claim 11, further comprising:
at least two friction hinges pivotably coupled to the display panel and the support panel, wherein the two friction hinges are disposed at the same distance away from the main pivot.

15. The lottery ticket terminal of claim 11, wherein the display panel includes an central opening configured to accommodate a monitor in a low profile configuration.

16. The lottery ticket terminal of claim 11, wherein the friction hinge is configured to slide along tracks disposed on the display panel and the support panel, such that the distance between the friction hinge and the main pivot increases as the angle between the display panel and the support panel increases.

17. The lottery ticket terminal of claim 11, wherein the friction hinge is configured to slide along tracks disposed on the display panel and the support panel, such that the distance between the friction hinge and the main pivot decreases as the angle between the display panel and the support panel increases.

18. The lottery ticket terminal of claim 11, further comprising:
a plurality of detents located along the tracks.

19. The lottery ticket terminal according to claim 11, wherein the base houses at least one of a processor, a memory device, a disk drive, a printer, a scanner and an external device connector.

20. A display tilt device, comprising:
a monitor;
a display tilt device configured to couple the monitor to a base, wherein the display tilt device includes a display panel configured to support the monitor and pivotably coupled to the base at a main pivot;
and at least one friction hinge pivotably coupled to the display panel and the base, wherein the at least one friction hinge is disposed at a distance from the main pivot.
